(19) United States
(12) Patent Application Publication
(10) Pub. No.: US 2005/0201724 A1
(43) Pub. Date: Sep. 15, 2005

(54) Method and system for effect addition in a single multimedia clip

(76) Inventor: Sandy Chu, Taipei City (TW)

Correspondence Address: BIRCH STEWART KOLASCH & BIRCH, PO BOX 747, FALLS CHURCH, VA, 22040-0747, US

(21) Appl. No.: 10/798,395

(22) Filed: Mar. 12, 2004

(51) Int. Cl. H04N 5/783

(52) U.S. Cl. 386/68; 386/96

(57) ABSTRACT

A method and method for effect addition in a single multimedia clip are disclosed. By dividing video clip of a multimedia clip into a forward video clip and an afterward video and adding extended video clips after the forward video clip and before the afterward video clip, two separate video clips with an intersection in the time sequence are formed. Therefore the video effects can be added within the range of the intersection.

### BACKGROUND OF THE PRESENT INVENTION

1. Field of the Invention

The invention relates to a method and system for effect addition, and more particularly, to method and method for effect addition in a single multimedia clip.

2. Description of the Prior Art

When the price of video products is getting lower and lower, the utility rate of digital video and the demand of video editing also gradually increase. Video is recorded off and on. Namely, the contents of video are many separated clips whereby the needs for editing and linking these clips become important nowadays.

Effect addition richens the contents of video, which is the reason why they are often used in editing the multimedia clips. The multimedia clip must be imported into a data track in editing. A multimedia clip often contains a video clip and an audio clip. In the data track, the video clip and the audio clip are separately imported into the video track and the audio track of the data track. Besides, the video clip and the audio clip are synchronous in the time sequence and they are considered as a whole. Thus audio and video of a multimedia clip are copied, cut or moved at the same time. The effects can only be added within the intersection of the time sequence between two individual multimedia clips. Namely, two individual clips have to be imported into two individual data tracks and some part of them must overlap in the time sequence, then the effects can be added in the intersection overlapping in the time sequence.

When an effect is going to be added into a single multimedia clip, the forgoing method must be followed. The multimedia clip has to be cut into two separate multimedia clips and each of them is put into two different data tracks. Besides, the two clips must have the overlap of the time sequence between them. Afterward an effect can be added into the overlap. All of the forgoing efforts must be done by hand.

Therefore the overlap must be generated before the effects can be added within a signal multimedia clip in the prior art, all the actions have to be made to generate the overlap by hand. Then the effects can be added in the overlap. Referring to FIG. 1, the procedure of the prior art is shown. Firstly the multimedia clip with effect addition on demand at a specific time stamp is imported into a data track. The multimedia clip includes a video clip 121 and an audio clip 122 that are imported separately into a first video track 111 and a first audio track 112 of the data track. Then the user chooses a time stamp of the time sequence to divide the multimedia clip into a first multimedia clip and a second multimedia clip at the time stamp. The first multimedia clip is kept in the original data track and the video clip and the audio clip of it are still considered as the first video clip 121 and the first audio clip 122. The second multimedia clip is cut from the original multimedia clip and moved into another data track. The video clip and the audio clip of the second multimedia clip are considered as the second video clip 141 and the second audio clip 142 and imported into the second video track 131 and the second audio track 132 of the another data track from the time stamp. Afterward the first multimedia clip extends backward to generate a first extended video clip 152 and a first extended audio clip 162 of the first multimedia clip. In the meanwhile, the second multimedia clip extends forward to generate a second extended video clip 154 and a second extended audio clip 164 of the second multimedia clip. The process for extending must be done by hand and the video and audio are cut and extended at the same time because of the weakness of the present functions. Finally, effect addition can be made within the overlap between the time range of the first extended video clip and the second extended video clip. Besides, the first extended audio clip and the second extended audio clip must be muted for preventing from sound overlapping. Otherwise, the mix of original audio and extended audio sounds like noise and broken, and makes audience uncomfortable.

Accordingly, in the prior art, effects can only be added within the overlap of two different multimedia clips that each of them is in individual data track. Thus users suffer the handmade procedure for cutting a multimedia clip into two parts, separating them into two different data tracks, generating extended multimedia clips forward or backward for them, muting the audio clips of the generated extended multimedia clips and finally adding effects within the overlap of the time range between the generated extended multimedia clips. Then a new multimedia clip can be produced with effect addition and no sound overlapping. There are so many instructions needed to be done by hand.

Obviously, effect addition within a single multimedia clip takes a lot of complicate operations by hand. If there is too much work like such to do, it will be inefficient. Hence an improvement of the technique for solving this problem is needed.

### SUMMARY OF THE PRESENT INVENTION

One main purpose of the present invention is to provide a method for video editing. It is for the convenience of user to add effects within a single multimedia clip with successive video and audio.

According to the purposes described above, the present invention provides a method and system for effect addition within a single multimedia clip. By dividing a video clip of a multimedia clip into a first video clip 221 and a second video clip 241 and extending an extended video clip after the first video clip 221 and an extended video clip before the second video clip 241, an overlap of the two divided video clips is formed. Then effects can be added within the overlap. The present invention provides reduced procedure and methods for extending the extended video clips, and users can choose the most adaptive way to add effects quickly and conveniently.

### BRIEF DESCRIPTION OF THE DRAWINGS

A better understanding of the present invention can be obtained when the following Detailed Description is considered in conjunction with the following drawings, in which:

FIG. 1 is a diagram of the prior art;

FIG. 2 is a diagram of the present invention;

FIG. 3 is a function block diagram of one embodiment of the present invention; and

FIG. 4 is a diagram of another embodiment of the present invention.

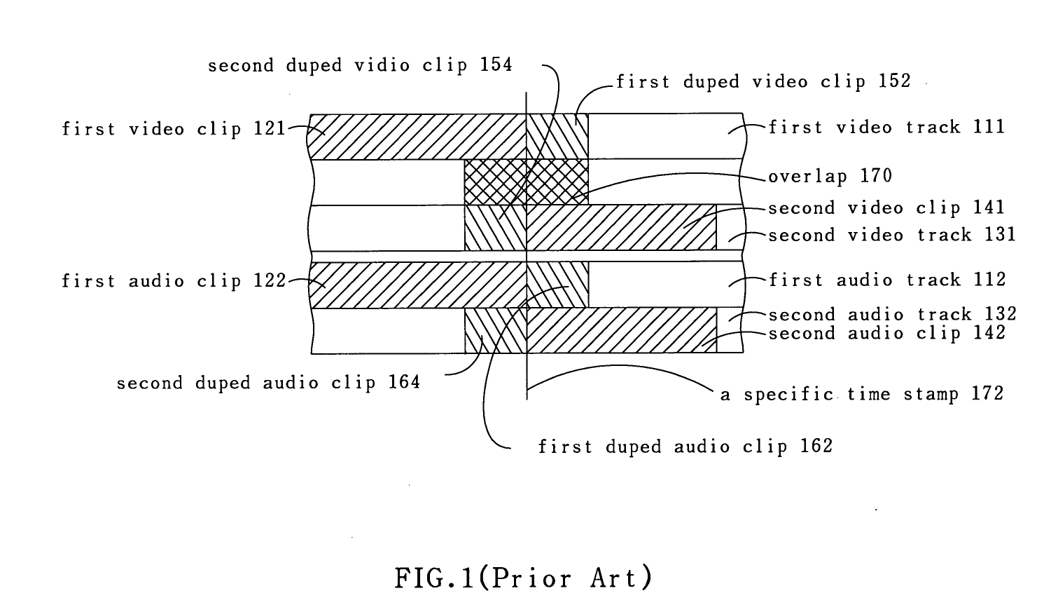

### DETAIL DESCRIPTION OF THE PREFERRED EMBODIMENT

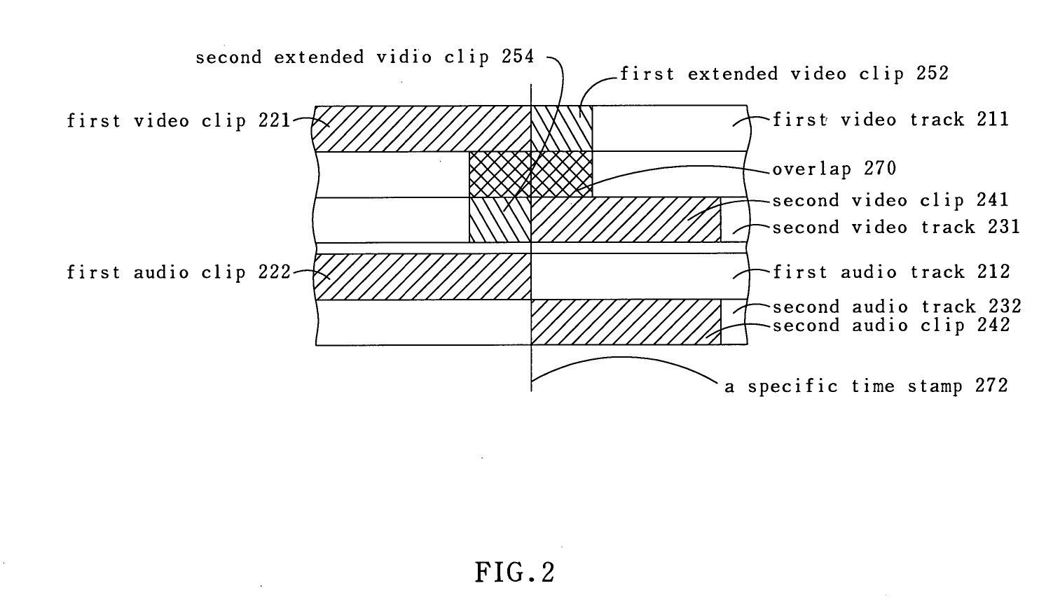

The present invention provides a method and a system for editing video. Users can choose a specific time stamp for adding effects, and the present invention can follow the instruction to make successive video and audio with expected effects. Referring to FIG. 2, when a multimedia clip is imported, the video clip and audio clip of the multimedia clip are imported into the first video track 211 and the first audio track 212. After users assign a specific time stamp and the size of an overlap 270, the present invention divides the multimedia clip into a former multimedia clip and a later multimedia clip. The former multimedia clip includes a first video clip 221 and a first audio clip 222, and the later multimedia clip includes a second video clip 241 and a second audio clip 242. The first video clip 221 and the first audio clip 222 are kept in the original first video track 211 and first audio track 212 separately. Then the second video clip 241 and the second audio clip 242 are moved to a second video track 231 and a second audio track 232 separately. The beginning of the second video clip 241 is next to the end of the first video clip 221 in the time sequence. Similarly, the beginning of the second audio clip 242 is next to the end of the first audio clip 222 in the time sequence. Then a first extended video clip 252 and a second extended video clip 254 are extended automatically and separately after the first video clip 221 and before the second video clip 241. Thus, an overlap 270 in time sequence for effect addition between the first extended video clip 252 and the second extended video clip 254 is formed. Afterward the next step of effect addition can be proceeded.

Moreover, the size of the forgoing first extended video clip 252 and second extended video clip 254 is adjustable. It means that the size of overlap 270 can vary. Namely, the size is user-defined or automatically generated according to a default size. For example, the size of the first video clip 221 and the second video clip 241 can be defined by users, or generated automatically according to the size of the overlap 270 defined by users. Or users can adjust the size afterward. The overlap 270 in the time sequence can be considered as the effect duration. Thus, the present invention does not limit the size and the manner for generating the size of the first extended video clip 252 and the second extended video clip 254.

Furthermore, there are various manners of generating the first extended video clip 252 and the second extended video clip 254, the present invention does not limit it. The generating manner can be any of the following:
freezing frame: all frames of the first extended video clip 252 are the last frame of the first video clip 221, and all frames of the second extended video clip 254 are the first frame of the second video clip 241;
duplicating video continuous frame: the portion of the second video clip 241 and the portion of the first video clip 221 within the effect duration are duplicated to be the first extended video clip 252 and the second extended video clip 254 separately;
fading in/out: a default color is used to fade out the first extended video clip 252 and fade in the second extended video clip 254; and
reversing and duplicating video continuous frame: the portion of the first video clip 221 and the portion of the second video clip 241 within the effect duration are duplicated and reversed to be the first extended video clip 252 and the second extended video clip 254 separately.

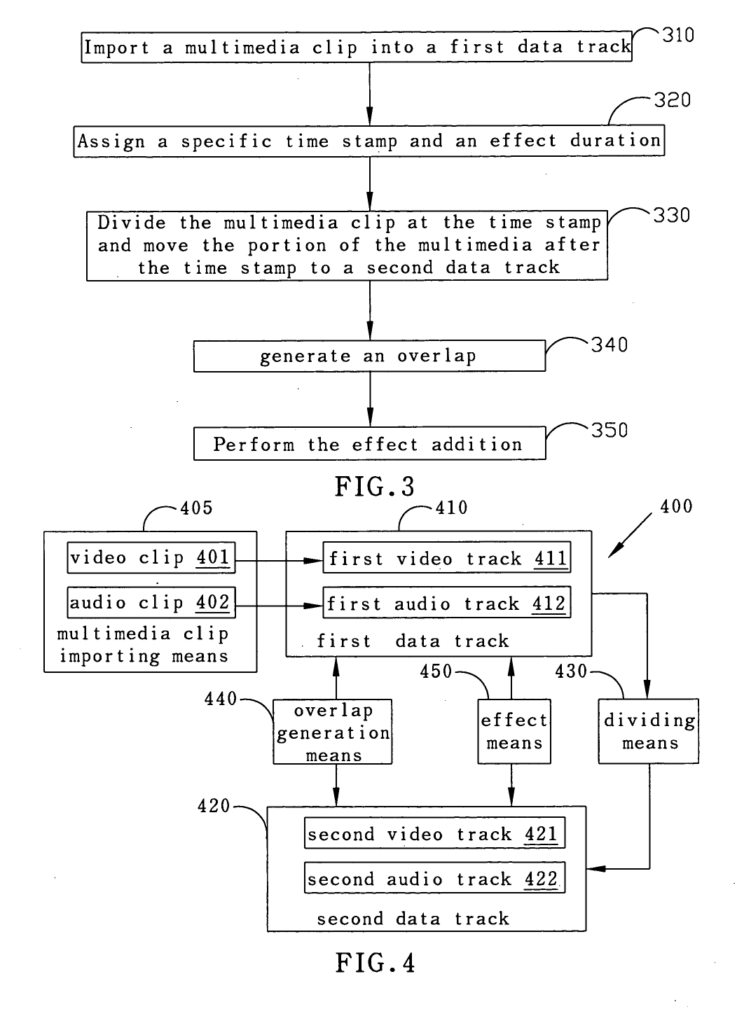

Accordingly, the present invention provides a method for effect addition within a single multimedia clip, referring to FIG. 3, a floating chart according to the method of the present invention. Firstly, step 310 imports the video clip and the audio clip of a multimedia clip that a user imports into a first video track and a first audio track of a first data track separately. The video and audio are synchronous in the time sequence. Then, step 320 determines a specific time stamp, effect duration and the type of the effect. The type of the effect can be fade-in, fade-out, zoom-in, zoom-out, rotation and so forth. Besides, the type of the effect can be user-defined or automatically generated by an editing system. Thus the type of the effect and the manner for generating the type are not limited in the present invention. Moreover, the position and size of the effect duration can be determined according to a specific time stamp and a time range defined by users. For example, if users want to add effects at a specific time stamp, the beginning and the end of the effect duration can be user-defined or the position and the size of the overlap can be determined by extending from the specific time stamp according to the effect duration. The specific time stamp is the position for dividing the multimedia clip. Thus the present invention does not limit the specific time stamp for dividing and the position and the size of the overlap.

Then step 330 divides the imported multimedia clip into a first multimedia clip before the specific time stamp and a second multimedia clip after the specific time stamp, and moves the second multimedia clip to a second data track according to its position in the time sequence. The multimedia clip includes the video clip and the audio clip, thus step 330 divides the multimedia into a first video clip and a first audio clip of the first multimedia clip and a second video clip and a second audio clip of the second multimedia clip. The first video clip and the first audio clip are kept in the first video track and the first audio track separately, and the second video clip and the second audio clip are moved to a second video track and a second audio track separately.

Afterward step 340 generates a first extended video clip extended backward from the end of the first video clip and a second extended video clip extended forward from the beginning of the second video clip. The manner for generating first extended video clip and the second extended video clip can be freezing frame, duplicating video continuous frames, reversing and duplicating video continuous frames, fading in/out and the like, which is not limited in the present invention. Besides, the present invention can only divide the video clip of the multimedia clip into the first video clip and the second video clip without touching the audio clip of the multimedia clip. The second video clip is moved to the second video track.

In step 320, the beginning and the end of the overlap, and the specific time stamp are determined. Thus the position in the time sequence of the first extended video clip is from the specific time stamp to the end of the overlap, and the best time range of it is half of effect duration. Similarly the position in the time sequence of the second extended video clip is from the beginning of the overlap to the specific time stamp and the best time range of the second extended video clip is half of effect duration. After that, an effect can be added within the overlap in step 350.

In the prior art, effects can only be added within the overlap of two different multimedia clips that each of them is in individual data track. Thus users suffer the handmade procedure for cutting a multimedia clip into two parts, separating them into two different data tracks, generating extended multimedia clips forward or backward for them, muting the audio clips of the generated extended multimedia clips and finally adding effects within the overlap of the time range between the generated extended multimedia clips. Due to the video and sound are duplicated as a whole, the duplicated sound must be muted for avoiding sound overlapping. Therefore, the method in the preferred embodiment of the present invention not only avoids the above-mentioned problem but also provides reduced procedure and many generating manners for extending video clips. The user can choose an adaptive setting for adding the best effects quickly and conveniently.

Accordingly, FIG. 4 is a diagram of another preferred embodiment of the present invention. A system 400 for effect addition within a single multimedia clip is provided and includes a first data track 410, a second data track 420, a dividing means 430, an overlap generation means 440, an effect means 450 and a multimedia clip importing means 405. The multimedia clip importing means 405 is used to import a video clip 401 and an audio clip 402 of an imported multimedia clip into a first video track 411 and a first audio track 412 of a first track 410 separately. Besides, dividing means 430 and effect means 450 are used to divide the multimedia clip into a former multimedia clip and a later multimedia clip according to a specific time stamp and an effect duration assigned by the user. In the time sequence, the former multimedia clip is before the specific time stamp, and the later multimedia clip is after the specific time stamp. Then the first video clip and the first audio clip of the former multimedia clip are kept in the first video track 411 and the first audio track 412 separately. The second video clip and the second audio clip of the later multimedia clip are moved to the second video track 421 and the second audio track 422 of the second track 420 by the dividing means 430. The beginning of the second video clip and the second audio clip are at the specific time stamp of the second track 420. The present invention highlights that only the video clip of the multimedia clip is divided and the later of cut video clip is moved to the second track. There is no modification of the audio clip.

Next, the overlap generation means 440 generates the overlap according to the received effect duration by the effect means 430. The process for generating the overlap is to extend a first extended video clip and a second extended video clip in the first video track 411 and the second video track 421 separately. The first extended video clip is extended from the end of the first video clip and the second extended video clip is extended from the beginning of the second video clip. The best size of the first extended video clip is half of the effect duration, and so is the second extended video clip. An overlap between the first data track and the second data track is generated. Also, the dividing means 430 can just divide and move the video clip without modifying the audio clip. Finally, effect means 450 is used to add effect within the overlap.

What are described above are only preferred embodiments of the invention, not for confining the claims of the invention; and for those who are familiar with the present technical field, the description above can be understood and put into practice, therefore any equal-effect variations or modifications made within the spirit disclosed by the invention should be included in the appended claims.

1. A method for effect addition within a single multimedia clip, comprising:
importing a multimedia clip into a first data track, said multimedia clip including a video clip and an audio clip;
assigning a specific time stamp and an effect duration, said specific time stamp being within the effect duration;
dividing said multimedia clip according to said specific time stamp, wherein said video clip is divided into a first video clip before said specific time stamp and a second video clip after said specific time stamp;
moving said second video clip to a second data track, wherein the beginning of said second video clip being at the specific time stamp in said second data track;
generating a first extended video clip and a second extended video clip to form an overlap according to said effect duration, wherein said overlap being between said first extended video clip extended backward from the end of said first video clip and said second extended video clip extended forward from the beginning of said second video clip; and
performing an effect addition, wherein said effect addition adding an effect within said overlap.

2. The method according to claim 1, wherein said audio clip is divided into a first audio clip and a second audio clip when said video clip is divided, and said second audio clip is moved to said second data track when said second video clip is moved.

3. The method according to claim 1, wherein said first extended video clip is extended by freezing frame according to the last frame of said first video clip.

4. The method according to claim 1, wherein said second extended video clip is extended by freezing frame according to the first frame of said second video clip.

5. The method according to claim 1, wherein said first extended video clip is extended by duplicating video continuous frames and said first extended video clip is generated according to the portion of said second video clip within said overlap.

6. The method according to claim 1, wherein said second extended video clip is extended by duplicating video continuous frames and said second extended video clip is generated according to the portion of said first video clip within said overlap.

7. The method according to claim 1, wherein the best size of said first extended video clip and said second extended video clip are respectively half of said effect duration.

8. The method according to claim 1, wherein said first extended video clip is extended by reversing and duplicating video continuous frames and said first extended video clip is generated according to the reverse of the portion of said first video clip within said overlap.

9. The method according to claim 1, wherein said second extended video clip is extended by reversing and duplicating video continuous frames and said second extended video clip is generated according to the reverse of the portion of said second video clip within said overlap.

10. The method according to claim 1, wherein said first extended video clip and said second extended video clip are separately produced by fading in and fading out a default color.

11. A system for effect addition within a single multimedia clip, comprising:
a first data track for importing a multimedia clip including a video clip and an audio clip;
a second data track;
a dividing means for dividing said multimedia clip into a first video clip before a specific time stamp and a second video clip after said specific time stamp and moving said second video clip to said second data track;
an overlap generation means for extending a first extended video clip backward from the end of said first video clip and a second extended video clip forward from the beginning of said second video clip to form a overlap between said first extended video clip and said second extended video clip; and
an effect addition means for adding an effect within said overlap.

12. The system according to claim 11, wherein said dividing means divides said audio clip into a first audio clip and a second audio clip when said video clip is divided, and moves said second audio clip to said second data track when said second video clip is moved.

13. The system according to claim 11, wherein said first extended video clip is extended by freezing frame according to the last frame of said first video clip.

14. The system according to claim 11, wherein said overlap generation means produces all frames of said second extended video clip by using the first frame of said second video clip.

15. The system according to claim 11, wherein said overlap generation means extends said first extended video clip by duplicating video continuous frames, and said first extended video clip is generated according to the portion of said second video clip within said overlap.

16. The system according to claim 11, wherein said overlap generation means extends said first extended video clip by reversing and duplicating video continuous frames and said first extended video clip is generated according to the reverse of the portion of said first video clip within said overlap.

17. The system according to claim 11, wherein said overlap generation means extends said second extended video clip by reversing and duplicating video continuous frames and said second extended video clip is generated according to the reverse of the portion of said second video clip within said overlap.

18. The system according to claim 11, wherein said overlap generation means extends said second extended video clip by reversing and duplicating video continuous frames and said second extended video clip is generated according to the reverse of the portion of said second video clip within said overlap.

19. The system according to claim 11, wherein said overlap generation means produces said first extended video clip and said second extended video clip are separately produced by fading in and fading out a default color.

20. The system according to claim 11, wherein the best size of said first extended video clip and said second extended video clip are respectively half of said effect duration.
